(19) United States
(12) Patent Application Publication
(10) Pub. No.: US 2026/0212291 A1
(43) Pub. Date: Jul. 23, 2026

(54) TASK MANAGEMENT SYSTEM

(71) Applicant: Provenir Group Holdings, LLC, Parsippany, NJ (US)

(72) Inventor: Raymond A. Monaco, Killeen, TX (US)

(73) Assignee: Provenir Group Holdings, LLC, Parsippany, NJ (US)

(21) Appl. No.: 19/032,543

(22) Filed: Jan. 21, 2025

(51) Int. Cl. G06Q 10/0631

(52) U.S. Cl. CPC G06Q 10/063118; G06Q 10/06311; G06Q 10/063114; G06Q 10/06316; G06Q 10/0635; G06Q 10/1097

(57) ABSTRACT

A computing system receives information associated with a task for an eligibility assessment workflow. The computing system generates one or more tasks based on the information by generating one or more data structures. The computing system populates a task management dashboard with graphical elements corresponding to the one or more tasks that were generated. Each graphical element corresponds to a task card comprising visual indicators of the task identifier, the description, the due date, and the assignee. The computing system monitors progress of the one or more tasks to ensure compliance with the due date. The computing system analyzes the progress of the one or more tasks to determine that a task should be flagged. Based on the analyzing, the computing system generates and pushes a notification to the assignee to flag the task.

### FIELD OF DISCLOSURE

The present disclosure generally relates to task management system and, more specifically, to a task management system and improved dashboard for streamlining workflow processes.

### BACKGROUND

There are many software applications that assist users in managing workflows and tasks associated with these workflows. Often these software applications fall into one of two categories: either they leave a lot to be desired in terms of functionality or they are overly complicated and difficult to use. As a result, organizations are typically left searching for workflow management systems that satisfy only a portion of their desired functionalities resulting in a siloed and/or partitioned platform for their team.

### SUMMARY

In some embodiments, a method is disclosed herein. A computing system receives information associated with a task for an eligibility assessment workflow. The information includes a task identifier, a description, a due date, and an assignee for the task. The computing system generates one or more tasks based on the information by generating one or more data structures comprising the task identifier, the description, the due date, and the assignee. The computing system populates a task management dashboard with graphical elements corresponding to the one or more tasks that were generated. Each graphical element corresponds to a task card that includes visual indicators of the task identifier, the description, the due date, and the assignee. The computing system monitors progress of the one or more tasks to ensure compliance with the due date. The computing system analyzes the progress of the one or more tasks to determine that a task should be flagged. Based on the analyzing, the computing system generates and pushes a notification to the assignee to flag the task.

In some embodiments, a non-transitory computer readable medium is disclosed herein. The non-transitory computer readable medium includes one or more sequences of instructions, which, when executed by a processor, causes a computing system to perform operations. The operations include receiving, by the computing system, information associated with a task for an eligibility assessment workflow. The information includes a task identifier, a description, a due date, and an assignee for the task. The operations further include generating, by the computing system, one or more tasks based on the information by generating one or more data structures comprising the task identifier, the description, the due date, and the assignee. The operations further include populating, by the computing system, a task management dashboard with graphical elements corresponding to the one or more tasks that were generated. Each graphical element corresponds to a task card comprising visual indicators of the task identifier, the description, the due date, and the assignee. The operations further include monitoring, by the computing system, progress of the one or more tasks to ensure compliance with the due date. The operations further include analyzing, by the computing system, the progress of the one or more tasks to determine that a task should be flagged. The operations further include, based on the analyzing, generating and pushing, by the computing system, a notification to the assignee to flag the task.

In some embodiments, a system is disclosed herein. The system includes a processor and a memory. The memory has programming instructions stored thereon, which, when executed by the processor, causes the system to perform operations. The operations include receiving information associated with a task for an eligibility assessment workflow. The information includes a task identifier, a description, a due date, and an assignee for the task. The operations further include generating one or more tasks based on the information by generating one or more data structures comprising the task identifier, the description, the due date, and the assignee. The operations further include populating a task management dashboard with graphical elements corresponding to the one or more tasks that were generated. Each graphical element corresponds to a task card comprising visual indicators of the task identifier, the description, the due date, and the assignee. The operations further include monitoring progress of the one or more tasks to ensure compliance with the due date. The operations further include analyzing the progress of the one or more tasks to determine that a task should be flagged. The operations further include, based on the analyzing, generating and pushing a notification to the assignee to flag the task.

### BRIEF DESCRIPTION OF THE DRAWINGS

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating a computing environment, according to example embodiments.

FIG. 2 is a block diagram illustrating the task management engine of the server system of FIG. 1, according to example embodiments.

FIG. 3 is a block diagram illustrating the analytics module of the server system of FIG. 1, according to example embodiments.

FIG. 4A is an exemplary graphical user interface, according to example embodiments.

FIG. 4B is an exemplary graphical user interface, according to example embodiments.

FIG. 5 is a flow diagram illustrating a method of generating and tracking tasks for an eligibility assessment, according to example embodiments.

FIG. 6A is a block diagram illustrating a computing device, according to example embodiments of the present disclosure.

FIG. 6B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

Institutions often face several critical challenges when making decisions, particularly those related to eligibility assessments. Many institutions manage a high volume of applications, which require thorough evaluation, compliance checks, and timely decisions. Maintaining accuracy while managing these processes efficiently is a considerable challenge. Failing to adhere to compliance standards and service level agreements (SLAs) can result in legal penalties and financial losses. Convention eligibility assessment systems typically do not provide real-time updates or detailed tracking of each step in an eligibility assessment workflow, leading to delays, miscommunications, and a lack of accountability. If eligibility assessments are not centralized and systematic, inconsistencies and biases can occur, affecting the quality and reliability of the decision. Traditional systems often lack comprehensive tools for monitoring these aspects, resulting in inefficient resource allocation and team productivity tracking.

Conventional solutions for managing eligibility assessments typically include manual processes and spreadsheets, legacy decisioning software, enterprise resource planning (ERP) systems, specialized platforms, and custom-built solutions. However, these methods often have significant drawbacks such as being labor-intensive, prone to errors, lacking real-time monitoring, or lacking integration.

As those skilled in the art understand, manual processes and spreadsheets are inconsistent and inaccuracies in the data typically result from these approaches being labor-intensive and prone to human error. Moreover, these approaches lack real-time information tracking and integration, thus making managing large amounts of information difficult. These systems are also unable to provide a centralized or transparent view of all activities in the eligibility assessment process, which leads to inefficiencies and challenges in ensuring compliance.

Legacy systems are often inefficient and difficult to use due to outdated technology, limited integration capabilities, and poor user interfaces. Modern regulatory requirements and changing business needs may not be easily adjusted to them. Moreover, these systems typically lack real-time processing and advanced analytics, which are necessary for timely and accurate credit decision-making in a fast-paced environment. Moreover, while ERP systems provide broad functionality, they do not specialize in eligibility assessments and may lack specific features needed to track compliance and conduct detailed analysis. Implementation can be complex and expensive, requiring substantial customization to meet specific requirements.

Specialized tools typically only address specific aspects of the process. For example, one of the bigger drawbacks of specialized platforms are their limited scope. While they may excel in certain areas, they typically do not provide comprehensive coverage for the entire eligibility assessment workflow. As a result, institutions often have to rely on multiple tools, which can create integration challenges and data silos. Managing and synchronizing different systems can also become more complex as a result. Furthermore, these solutions may not be easily adaptable to changing business needs due to their lack of flexibility and scalability.

Although custom-built solutions are tailored to specific needs, they can be costly and challenging to maintain. For example, custom-built solutions typically require substantial investment in information technology resources and typically do not keep pace with evolving technologies and regulatory changes, resulting in potential obsolescence. Additionally, these solutions are complex and unique, making it difficult to hire or train personnel capable of managing and supporting them.

As a result, existing techniques do not offer a comprehensive, real-time, and user-friendly system that effectively addresses all eligibility assessment requirements.

To improve upon conventional approaches, one or more techniques disclosed herein provide an improved platform that addresses the various challenged encountered by institutions. For example, one or more techniques provided herein provide a platform that manages intricate tasks while meeting regulatory requirements, as well as providing live tracking and ensuring consistent decision-making. This integrated approach not only effectively solves the aforementioned limitations of convention systems but also delivers additional advantages, such as efficient resource allocation and enhanced user experience. As a result, the present platform provides a forward-thinking solution to eligibility assessment processing.

For example, the present platform provides a comprehensive and integrated solution that simplifies the management of high-volume and intricate tasks through a well-organized system. This results in a reduction of manual workloads, minimizing errors and enabling efficient handling of credit applications. In some embodiments, the platform may include compliance tracking functionality throughout the process, featuring automated reminders and alerts for regulatory deadlines to ensure adherence to strict regulations. In some embodiments, the platform may employ feal-time monitoring functionalities that allow for continuous oversight, while detailed activity logs promote accountability by providing a transparent record of actions taken.

Moreover, the platform guarantees consistency in decision-making by utilizing standardized workflows and criteria, eliminating biases and promoting impartial treatment of all applicants. It also offers built-in tools for monitoring productivity and resource distribution, enabling institutions to streamline their operations and detect any inefficiencies. The user-friendly interface facilitates easy navigation, shortens the learning process, and reduces mistakes, enhancing the overall user experience. Furthermore, its integrated analytics and reporting features provide comprehensive decision support, enabling data-driven choices that enhance precision and dependability in the credit evaluation process. In summary, this platform greatly enhances operational efficiency, compliance, and decision-making for organizations.

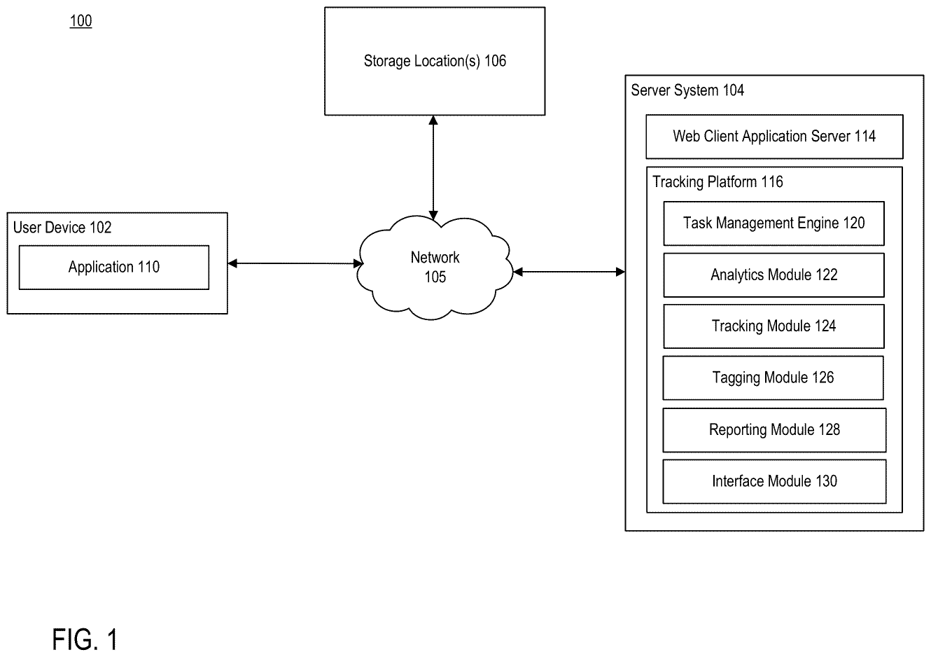

FIG. 1 is a block diagram illustrating a computing environment 100, according to example embodiments. Computing environment 100 may include user device 102, server system 104, and storage location 106 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

User device 102 may be operated by a user, such as, for example, a user associated with an organization. User device 102 may be representative of a mobile device, a tablet, a desktop computer, or any computing system having the capabilities described herein. User device 102 may include an application 110 executing thereon. Application 110 may be representative of an application associated with server system 104. For example, application 110 may be representative of an application that utilizes an eligibility assessment tracking platform, such as tracking platform 116 associated with server system 104. In some embodiments, application 110 may be a standalone application associated with server system 104, such as a mobile application, tablet application, desktop application, or, more generally, a software application affiliated with an entity associated with server system 104. In some embodiments, application 110 may be representative of a web browser configured to communicate with server system 104, such that an end user may gain access to tracking platform 116 of server system 104 via a web browser. More generally, application 110 may be configured to provide an interface between user device 102 and server system 104 for the purpose of allowing a user to access tracking platform 116.

Server system 104 may be representative of one or more servers configured to communicate with one or more user devices, such as user device 102. In some embodiments, server system 104 may be configured to host one or more virtualization elements (e.g., virtual machines or containers), such that components of server system 104 may be upscaled or downscaled, depending on demand or user request.

Server system 104 may include web client application server 114 and tracking platform 116. Tracking platform 116 may be representative of eligibility assessment suite of tools that are configured or design to assist institutions in managing and streamlining their eligibility assessment processes. For example, tracking platform 116 may provide organizations with the functionality to manage, track, and update tasks and reminders. In some embodiments, tracking platform 116 may function as a software-as-a-service (Saas) platform to streamline and manage eligibility assessment processes. Tracking platform 116 may include unique workflows and functionalities to optimize task management, compliance tracking, and accuracy of decision making.

Tracking platform 116 may include task management engine 120, analytics module 122, tracking module 124, tagging module 126, reporting module 128, and interface module 130. Each of task management engine 120, analytics module 122, tracking module 124, tagging module 126, reporting module 128, and interface module 130 may be comprised of one or more software modules. The one or more software modules are collections of code or instructions stored on a media (e.g., memory of server system 104) that represent a series of machine instructions (e.g., program code) that implements one or more algorithmic steps. The machine instructions may be the actual computer code the processor of server system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Task management engine 120 may be configured to allow end users to create and manage tasks for a given workflow. An example workflow may be an eligibility assessment, such as, but not limited to a credit decision. In operation, task management engine 120 may receive, as input, detailed task information for the eligibility assessment and, based on the task information, may generate one or more tasks for a given assessment or workflow. In some embodiments, the task information may include, but is not limited to, task identifiers, descriptions, due dates, and assignees. In some embodiments, task management engine 120 may be configured to categorize tasks according to predefined criteria and/or statuses. Exemplary statuses may include, but are not limited to “new,” “pending,” “in-flight, and “closed.”

Task management engine 120 may further be configured to provide end users with a flexible workflows through the use of workflow templates. In some embodiments, task management engine 120 may employ a rules engine, which automates tasks/cast status decision based on rules. In some embodiments, task management engine may include a notification mechanism that keeps key stakeholders updated with case and tasks status. In some embodiments, task management engine 120 may include an analytics module that measures case progress and generates insights data. Task management engine 120 may be configured for efficiency and adaptability of workflow through the use of user initiated tasks, templates, and repeat schedules. In some embodiments, task management engine 120 may allow users to add content manually using the interface including task description, due date, priority and assignees. This is what allows for flexibility for individual, one-off workflows. In some embodiments, task management engine 120 may provide users with task templates that make creating repetitive or standard tasks simple. These templates can be used by users to keep repeating tasks consistent and efficient. In some embodiments, task management engine 120 may allow for automated task creation at regular intervals (e.g., daily, weekly, monthly), delaying manual efforts on standard tasks and executing recurring tasks at an early stage. Together, these features add to user's control, stability, and productivity, with the least possible manual input and error. Task management engine 120 is scalable to fit different workflows and different use cases from single users to enterprises. As will be described in more detail below, task management engine 120 may include several functionalities, such, as but not limited to, automated task generation using rules-based triggers, event-based actions, artificial intelligence, machine learning, and/or natural language processing algorithms. These features combined together offer an elegant, user-friendly task automation platform that boosts productivity, minimizes manual work, and offers smart task suggestions based on user needs.

In some embodiments, task management engine 120 may be configured to generate tasks automatically. In some embodiments, task management engine 120 may employ rule-based triggers for generating tasks. Rule-based triggers may be representative of specific rules or conditions that may cause task management engine 120 to create a task. Rule based triggers may be used to generate one or more jobs on an automatic basis using one or more rules or parameters. An exemplary rule based trigger may include a date coming soon trigger, which automatically builds or generates a reminder task before a deadline. Another exemplary rule based trigger may be a dependency completion trigger, which performs subsequent tasks when perquisite tasks are checked as done. Rule based triggers provide operators with the technical benefit of proactive task generation per workflow.

In some embodiments, task management engine 120 may employ event-based tasks that, when certain events are detected, may cause task management engine 120 to automatically generate a task. Event based tasks may be representative of tasks that are generated in a dynamic manner based on actual system events. An exemplary event based trigger may be a form submit trigger, which generates a post review task upon the event of a form submission. Another exemplary event based trigger may be a workflow stage finishing trigger, which defines next steps of a task when a workflow stage is completed. Another exemplary event based trigger may be a milestone achievement trigger, which generates celebration or summary tasks automatically when a project milestone is achieved. Event based triggers provide the technical benefit of allowing tasks to adapt dynamically in real-time to system activities while they are running, maintaining the continuous execution of the tasks.

By combining rule-based logic with event-based automation, task management engine 120 provides end users with a flexible and fast approach to creating tasks, resulting in a task generation process that is easier for users. Task management engine 120 may enable workflows to be run in real-time and may allow for context-aware tasks to be automatically generated. These technical features differentiate tracking platform 116 from conventional platforms as a next-generation task automation and management tool.

For example, task management engine 120 may employ artificial intelligence, machine learning, and/or natural language processing technologies for smart task suggestion and generation. The smart task suggestion and generation functionalities can assist users in making more productive use of the tools and save time by automating decision-making and task-development.

In some embodiments, task management engine 120 may generate task suggestions using one or more artificial intelligence and/or machine learning algorithms based on task history and user history to assign new tasks and organize current tasks. For example, task management engine 120 may suggest an extra meeting activity, responsive to detecting a pattern of tasks for similar projects. Using another example, task management engine 120 may be configured to automatically organize tasks by content, priority, or context to make task organization easier for end users. By proactively anticipating and suggestion tasks a user is likely to create, task management engine 120 simplifies the process from the perspective of the user. Through various intelligence techniques, task management engine 120 improves task management, prioritization, and workflow.

In some embodiments, task management engine 120 may utilize natural language processing for action item interpretation. For example, task management engine 120 may use natural language processing techniques to draw or infer a practical purpose from unstructured input from users. For example, task management engine 120 may utilize natural language processing techniques to analyze one or more of meeting notes, emails, and/or text messages to infer a practical purpose from the data. In some embodiments, through the use of natural language processing technology, task management engine 120 may be configured to extract text commands from notes, emails, or text messages to identify action items and convert those action items into tasks. Using a specific example, task management engine 120 may be configured to parse meeting notes, identify a text command (e.g., “Do a presentation next Friday”), and convert the text command into a task with description, due date, and assignee. Such functionalities provides end users with a context aware system that is able to infer action items on behalf of users. Through this process, task management engine 120 makes task creation easier, in particular for users with large amount of unstructured data and also provides users with accurate and efficient automation of task details. Exemplary pseudocode for natural language processing task extraction may be:

Through the use of artificial intelligence, machine learning, and/or natural language processing techniques, task management engine 120 provides game-changing task automation solution by providing predictive task recommendation based on the historical data, providing automatic task generation from messy data with precision, and improving workflow and user experience with automation intelligence. These features make task management engine 120 a next-gen task management platform that delivers unmatched personalization and productivity.

In some embodiments, task management engine 120 may be configured to integrate with other third-party systems for the purpose creating tasks. In some embodiments, task management engine 120 may include an API integration that may allow end users to take advantage of external applications that can create tasks. In some embodiments, task management engine 120 may use one or more API integrations to interface with customer support systems to automatically create tasks from support tickets. In some embodiments, task management engine 120 may use one or more API integrations to interface with one or more CRMs to design activities or tasks based on updates from the CRM. Exemplary design activities may be to follow up with a lead or follow up with a calendar event. In some embodiments, task management engine 120 may use one or more API integrations to interface with one or more third party project management tools to create tasks. Exemplary tasks may include tasks when milestones are met or dependences changed. By providing various API integrations, task management engine 120 improves integration between task management engine and popular business tools and provides for automatic task creation functionality, eliminating the need for manual entry, thereby more efficiently streamlining workflow.

In some embodiments, task management engine 120 may further include email or chat integration, such that tasks may be created from chat and email. For example, users can forward email items or flag them for manual generation of task-oriented assignments. In some embodiments, such as for email integration, task management engine 120 may automate task generation through email by parsing the user's inbox for certain key words or phrases (e.g., “Present presentation on Friday”). In some embodiments, task management engine 120 may be configured to build tasks based on marked messages in collaboration channels (e.g., Slack, Teams).

Through the use of API integrations and communication channel integration, task management engine 120 may provide for the automation of task generation from third party tools and communication tools, integration with other systems for seamless workflow, and automated manual tasks and automated task generation within both structured and unstructured environments. These integration features provide a complete and flexible solution in the task automation and management market.

In some embodiments, task management engine 120 may further provide functionalities related to task categorization and status management. In some embodiments, task management engine 120 may include pre-created status groups for easy task tracking and progress management. Exemplary status categories may include new, pending, in-flight, and closed. The new category may correspond to tasks created but not yet performed. The pending category may correspond to tasks that are waiting for other external input or required to start. The in-flight category may correspond to current work in progress. The closed category may correspond to items done or resolved. The pre-created status groups provide several benefits, such as providing an easily digestible workflow for work flow, allowing users to prioritize and attend to tasks that are already on or in progress, and allows for the management of tasks in a simpler manner, that saves users time.

In some embodiments, task management engine 120 may allow users to create custom labels for more granular organization. Exemplary custom labels may include, as seen on TV (e.g., identify important tasks to take care of in real time), research (e.g., scope activities to be investigated or studied), and team-wide labels (e.g., allow departments to set label (e.g., “QA Review,” “Client,” “feedback”).

This approach offers elasticity for users to tailor the system to their own workflow, improves search and sorting, allowing users to find tasks in seconds based on label, and supports many different use cases from personal task management to big teams.

Task categorization and status tracking provides users with a flexible and customizable task management/tracking tool by improving visibility for task lifecycle with defined statuses and allowing users to organize the items with labels they set up on the fly. With these features, task management engine 120 may be configured to support various workflows—from individual use cases to corporate task management—and is a complete and flexible task automation solution.

In some embodiments, task management engine 120 may be configured to assign tasks to certain users. In some embodiments, task management engine 120 may employ a role-based task generation approach in which, task management engine 120 may automatically assign tasks based on a user's role within the organization. For example, task management engine 120 may be configured to automatically distribute work in line with organizational roles to be matched to the rights of access and expertise of the user. In some embodiments, task management engine 120 may employ a role-based access control, in which only users with appropriate roles or permissions get tasks. For example, management approval work may only be sent to users in management roles. In some embodiments, task management engine may employ a dynamic role mapping technique, in which task assignments may be updated with changing roles of users or the organization. Through these techniques, task management engine 120 may enforce organization level of security and access, automate task distribution by automating manual labor, and prevent errors due to not transferring work to unknown users.

In some embodiments, such as those involving collaborative tasks (e.g., “group” tasks), task management engine 120 may be configured to generate tasks that include multiple assignees, allowing teams to work collectively on shared responsibilities. In some embodiments, task management engine 120 may be configured to distribute a task to multiple users/teams to work together. For example, task management engine 120 may delegate the task—“Prepare Quarterly Report”—to a finance team. Through this process, task management engine 120 encourages cooperative tracking by enabling all assignees to track work that everyone on the team can see. In some embodiments, task management engine 120 may assign tasks within the group based on role-determined contributions based on an indicated role an individual may play within the group (e.g., reviewer, contributor, etc.). Through this functionality, task management engine 120 improves team alignment and responsibility, enables division of labor for complex or multi-step processes, and enables transparency and oversight of work progress for everyone. Through role-based and collaborative assignment capabilities, task management engine 120 may provide effective and safe assignment of tasks to both individual and collective employees, thereby providing accurate task synchronization with user roles for compliance and performance improvement and adjustable group task management for simple collaboration on group tasks.

The various features of task management engine 120 aim to streamline task creation, enhance tracking, and improve overall efficiency in task management by ensuring tasks are generated effectively and categorized appropriately. Combining all these capabilities makes task management engine 120 a full-featured solution for task allocation, customizable to organizational workflows and architectures, and optimized for individual and team efficiency.

Analytics module 122 may be configured to process and/or analyze user activities, task progress, and/or SLA compliance. In some embodiments, analytics module 122 may be configured to process and/or analyze user activities, task progress, and/or SLA compliance in accordance with labels, generated by task management engine 120, that may indicate the current status and urgency of tasks in real-time or near real-time. Analytics module 122 may further be configured to provide insight into the performance of individuals and teams by tracking metrics such as task completion rates and time spent working.

Analytics module 122 may be configured to interface with task management engine 120 for an all-in-one, real-time analytics engine for task management, productivity management, and SLA management. This combination guarantees analytics-based decision making and project-based task management to improve workflow, productivity, and conformity with organizational guidelines.

In some embodiments, analytics module 122 may be configured to utilize the labeling system of task management engine 120 for monitoring and dynamic task status. For example, analytics module 122 may be configured to continuously monitor and update task labels in real-time, with useful information about tasks status and progress. In this manner, analytics module 122 is able to monitor progress tasks and queues by status and provide end users with metrics related to completion and timeliness.

In some embodiments, analytics module 122 may be configured to measure team and user activities towards tasks to evaluate workload distribution, task management, and productivity. Exemplary metrics tracked by analytics module 122 may include, but are not limited to task generation, revision, redo and timeline, task throughput and rates over certain times, and reopen rate which is low due to quality problems. Through this process, analytics module 122 may be configured to detects load and allocation imbalances, report on individual and team efficiency for continual optimization, and alert key users about quality issues in task reopening.

In some embodiments, analytics module 122 may be configured to monitor SLA compliance as the tasks are progressed based on deadlines and SLA's. In some embodiments, analytics module 122 may include escalation mechanisms, such as push notifications, escalations or reallocations, when SLA thresholds are projected to be violated. In some embodiments, analytics module 122 may employ defensive actions when predicted SLA breaches occur in real-time data and trends.

In some embodiments, analytics module 122 may be configured to analyze the user behavior and activity for trends and improvements. Analytics module 122 may be configured to track various metrics, such as, but not limited to time active on tasks or workflows, amount of time not working in indicate abandoned tasks, and benchmarking of individuals and teams. Through this functionality, analytics module 122 may be configured to identify user training or support requests, identify star and performance improvement opportunities, and monitor performance over time for business planning.

In some embodiments, analytics module 122 may be configured to generate a granular view of task lifecycles and workflow bottlenecks for process optimization. Analytics module 122 may be configured to track various metrics, such as, but not limited to average task time and time in each status, ratios of throughput and efficiency for task, and use of resources per task type. Through this functionality, analytics module 122 may be configured to detect bottlenecks and waste in tasks, estimate task time to define achievable goals and reduce processes, and monitor productivity data to drive allocation.

In some embodiments, analytics module 122 may be configured to provide users and managers real-time data to make better decisions. In some embodiments, analytics module 122 may be configured for real-time resource allocation. For example, analytics module 122 may be configured to move resources back to urgent items as urgency values change. In some embodiments, analytics module 122 may be configured to manage attribute priority by, for example, defining the most important work in terms of priority and SLA-risk. In some embodiments, analytics module 122 may be configured for task management. For example, analytics module 122 may be configured to detect or project delays or risks and suggest interventions to reduce bottlenecks or SLA violations.

Combining analytics module 122 and task management engine 120, makes task management a data-driven affair by delivering real time visibility of tasks, user activity and SLAs, delivering predictive tasks and resource forecasting for proactive work, and improving operational efficiency through process optimizations. Analytics module 122 and task management engine 120 establish a strong process for task and case management, enabling organizations to automate processes, be compliant, and get more done through intelligent, analytics-based automation.

Tagging module 126 may be configured create a customized list or tag to organize tasks according to specific themes or priorities. Exemplary themes or priorities may include but are not limited to such as “compliance review” or “financial assessment.” Tagging module 126 may allow users to tailor their workflow to meet their specific needs and comply with regulatory requirements, enhancing the platform's flexibility. In operation, tagging module 126 may provide users with the functionalities to create and assign tasks. For example, through tagging module 126, users can create their own tags based on their specific needs. For example, a user might create tags such as “legal review,” “QA check,” or “client onboarding.” Tagging module 126 may provide users with the functionality to assign tags to tasks individually or in bulk. Tagging module 126 may also support assigning multiple tags to a single task if it falls under more than one category, allowing for versatile task organization. In some embodiments, tagging module 126 may generate and cause for presentation an interface that provides users with a view of their task lists that reflect their current focus, such as all high-priority compliance tasks or in-progress financial reviews.

Tagging module 126 may provide users with the functionality to create custom tags to categorize tasks according to specific themes, such as “compliance review,” “financial assessment,” etc. In addition to reducing clutter, this arrangement makes it easier for users to locate, prioritize, and manage tasks based on their importance and urgency. Users can thus quickly retrieve tasks that contain specific tags, streamlining workflows and increasing productivity, especially in complex projects with a high volume of tasks.

In some embodiments, tagging module 126 may provide users with the functionality to customize tracking platform 116 to suit their specific needs, whether they are compliance, financial analysis, or project management teams. Tracking platform 116 thus becomes more effective for different types of users or departments when tags can be customized.

As priorities shift, users can adapt workflows dynamically to adapt to changing demands and deadlines more efficiently by using tags, such as “urgent” or “high priority.”

Tagging module 126 may further assist users with compliance with regulatory requirements and auditability. For example, tagging module 126 may provide users with the functionality to categorize and track tasks that are subject to regulatory requirements using custom tags, such as “compliance review.” In industries such as finance, healthcare, and legal, where certain tasks must follow strict guidelines, tagging these tasks ensures they are handled appropriately, reducing compliance risks.

Tagging module 126 may further assist users by providing them with an improved audit trail. For example, tags also serve as an audit trail, providing a clear record of tasks flagged for specific requirements. During audits or reviews, this organization makes it easier to identify tasks that meet specific regulatory or procedural standards.

In some embodiments, tagging module 126 may further enable managers to identify task themes quickly through the use of tags, such as high-priority financial assessments, enabling them to allocate resources effectively and focus resources on high-impact tasks.

In some embodiments, tagging module 126 may provide users with the functionality to streamline their workflows by categorizing tasks, thus allowing team members to focus on related tasks sequentially, minimizing context switching and increasing efficiency.

Tagging module 126 thus provides functionality for organizing, prioritizing, and ensuring regulatory compliance. Using predefined and customized tags, users can create an efficient and tailored workflow that meets their unique business needs and maintains high productivity and compliance standards.

Tracking module 124 may be configured to track service level agreements set by the end user. For example, tracking module 124 may track service level agreements to monitor deadlines and prioritize tasks based on contractual timelines set out in the task. In some embodiments, tracking module 124 may be configured to alert users to approaching deadlines and possible service level agreement breaches, thus ensuring that tasks are completed on time.

For example, tracking module 124 may be configured to manage tasks within the parameters set by SLAs and other deadlines. For example, in the context of SLAs and deadlines, tracking module 124 may be configured to monitor each task's assigned SLA or deadline, which could be set based on contractual obligations or organizational requirements. Tracking module 124 may be configured to continuously update tasks'status as they progress through various stages, so users can see the most current state at any time.

In some embodiments, tracking module 124 may further be configured to generate notifications and alerts based on priority. For example, tracking module 124 may be configured to alert users as tasks approach deadlines to let them know, so they can take action before they miss deadlines. Alerts can be visual (e.g., color-coded indicators) or in the form of push notifications, emails, or in-app messages. It is also possible to automatically escalate tasks that have breached SLAs by notifying supervisors or reallocating resources if they are at risk of or have already breached them.

Tracking module 124 may be configured to assist users in maintaining compliance with SLAs, for example, by prioritizing those tasks that need immediate attention. In some embodiments, tracking module 124 may be configured to prioritize tasks based on timelines. For example, tracking module 124 may be configured to automatically prioritize those tasks with nearer deadlines or critical SLA requirements, either by moving them to the top of the task list or by marking them as “urgent.”

In some embodiments, tracking module 124 may provide end users with the functionality to customize task views based on priority and SLA status allows users to easily access tasks that require immediate attention. In some embodiments, tracking module 124 may be configured to dynamically update a dashboard presenting tasks in real-time or near real-time in order to keep the users informed about task status. In some embodiments, the dashboard may include visual indicators of task status. Visual indicators of task status may include color-coded statuses. For example, the dashboard may include options for different colors corresponding to different statuses (e.g., “new” in blue, “in-progress” in yellow, “at-risk” in red), so users can quickly identify each task's status. Users can view task icons and labels that represent their current status (e.g., an exclamation mark for high-priority tasks, a clock for deadlines), offering a visual cue without having to open each task individually. The dashboard provides a high-level overview of all tasks and their statuses, showing the counts or percentages of tasks on track, at risk, or overdue. In some embodiments, the dashboard may include progress bars and countdown timers that can provide users with a real-time sense of urgency by visually showing how much time remains until a task's SLA deadline. In some embodiments, the dashboard may provide users with the functionality of filtering tasks based on their status, so they can quickly see tasks that are “pending,” “in-progress,” or “closed,” allowing users to focus on tasks that require immediate attention by filtering based on SLA compliance (e.g., tasks nearing deadlines). In some embodiments, the dashboard may provide users with functionality to sort tasks by priority or deadline, ensuring tasks with approaching deadlines are displayed at the top of the list. In some embodiments, tracking module 124 may generate a detailed activity log that may be included for each task, documenting status updates, changes, and actions taken. This history helps users understand how the current status was reached.

In some embodiments, tracking module 124 may be configured to generate a complete audit trail for SLA compliance in regulated environments, capturing when each task was created, updated, and completed. In the event that an SLA breach needs to be explained, this log can be used as a reference for compliance purposes.

In some embodiments, tracking module 124 may provide users with various types of user-specific notifications. In some embodiments, user-specific notifications may include role-based notifications. Role-based notifications can be tailored based on user roles, ensuring managers receive alerts about tasks nearing SLA breaches, while team members receive alerts for tasks assigned to them. In this way, tasks can be delegated effectively, and accountability can be ensured.

Through clear, actionable insights, tracking module 124, in combination with an intuitive dashboard for real-time updates, provides users the tools they need to manage their tasks proactively, meet SLA obligations, and enhance productivity. Tracking system's 116 structure prevents delays and breaches, ensuring smooth task progression and compliance.

Reporting module 128 may be configured to track and record user activities for the purpose of assessing performance and managing resources. In some embodiments, exemplary user activities that may be tracked include, but are not limited to, login times and actions performed with respect to a given task. In some embodiments, reporting module 128 may store each activity in a user activity log, which can be later referenced for auditing or productivity analysis.

Interface module 130 may be configured to generate a comprehensive dashboard of tasks generated by task management engine 120. In some embodiments, the dashboard may be segmented into a plurality of sections. The plurality of sections may include one or more of task categories (e.g., today, scheduled, flagged, all, etc.), detailed task entries, and user activity logs. The user interface may be designed for easy navigation, thus providing organizations with the ability to access information quickly and easily. In particular, the dashboard aims to improve productivity, accountability, and overall workflow management by allowing users to efficiently manage tasks and reminders, thus providing them with the functionality to meet deadlines and collaborate efficiently.

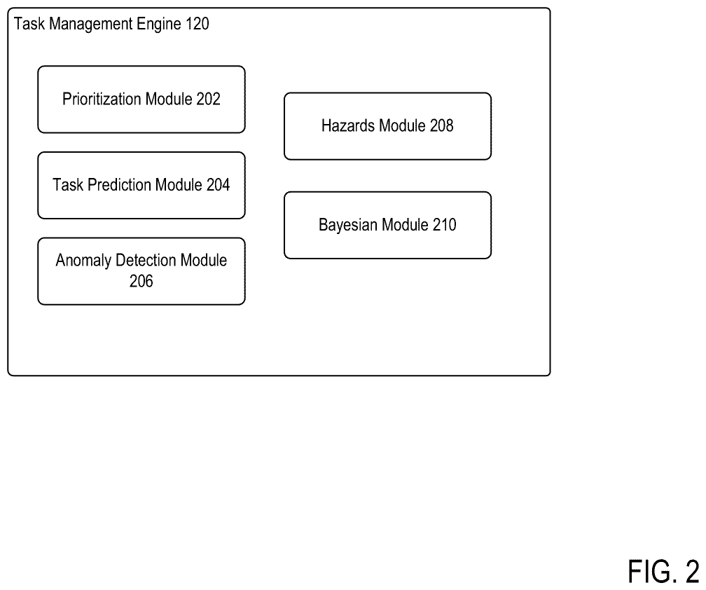

FIG. 2 is a block diagram illustrating task management engine 120, according to example embodiments. As shown, task management engine 120 may include one or more modules for improved task generation, priority and tracking for eligibility evaluation. Task management engine 120 may include one or more of prioritization module 202, task prediction module 204, anomaly detection module 206, hazards module 208, and Bayesian module 210.

Prioritization module 202 may be configured to predict high-priority tasks from a range of different criteria. In some embodiments, prioritization module 202 may consider one or more key features to determine whether a task needs urgent attention. Exemplary features may include deadline proximity (e.g., calculate how close tasks are to deadline), task complexity (e.g., determine task difficulty/resource required to finish the task), and competition time (e.g., take into account past task durations to flag overdue tasks). In some embodiments, prioritization module 202 may employ a logistic regression model to estimate urgency be weighted factors. Through use of the logistic regression model, prioritization module 202 may create probabilities for task prioritization, so resources are dynamically reallocated to key work. Through this process, prioritization module 202 may remove delays from completing high priority work by sending reminders, eliminates SLA violation and missed deadlines through early warnings, and optimizes work by dynamically dividing activities according to current data. Prioritization module 202 may be configured to evaluate and reevaluate a task's priority during the project lifecycle. This feature ensures urgent work gets identified, communicated and executed on time resulting in optimal resource allocation and workflow. Prioritization module 202 may be configured to use a logistic regression model to prioritize tasks in accordance with the urgency of that task based on deadline proximity (e.g., closely timed projects are taken up first), task complexity (e.g., more complex tasks might take more resources and planning which affects their urgency), and expected time to completion (e.g., timescales (little or big) in relation to deadlines have impact on priorities). In some embodiments, prioritization module 202 may generate a first urgency score. For example, when a task is created, prioritization module 202 may be configured to estimate an urgency score by logistic regression. In some embodiments, prioritization module 202 may be configured to dynamically reanalyze the task's priority. For example, when the task parameters (i.e., deadlines, complexity) change, prioritization module 202 may be configured to re-run the logistic regression model to change the urgency in real time. In a particular example, an item may initially be marked “not urgent” because of a distant due date but may be become “urgent” when the task's parameters are updated to reflect a new, sooner due date. In some embodiments, prioritization module 202 may be configured to generate alerts and/or notifications to enhance accountability and visibility. For example, prioritization module 202 may be configured to highlight potential tasks and generate alerts in real-time or near real-time (e.g., a user may receive alerts for activities meeting urgency criteria).

In some embodiments, prioritization module 202 may be configured to integrate with various dashboards. For example, prioritization module 202 may highlight or emphasize visually pressing work through color coding, filters, and alerts.

There are several reasons why prioritization is important. By identifying urgent tasks early, team members and managers can allocate resources effectively, ensuring that critical tasks receive the attention they require. Real-time updates prevent tasks from slipping through the cracks. Reevaluating urgency constantly ensures that no task's importance is underestimated as conditions change. In order to improve accountability and ensure priority tasks are not overlooked, urgent tasks are highlighted on dashboards and may include alerts.

As will be further explained below, prioritization module 202 may be configured to handle tasks with predictive analytics and machine learning tools. Integrating urgency prediction with other advanced modules (task prediction, anomaly detection, Bayesian reasoning), prioritization module 202 provides increased task prioritization to meet deadlines and reduce work inefficiencies inactive risk management and anomaly tracking for process security, and smart data-driven task management for highly dynamic workflows.

Task prediction module 204 may be configured to predict the number of new tasks due to be generated in a certain time frame. In some embodiments, task prediction module 204 may employ a regression-based model, such as, but not limited to a Poisson regression model, to predict the number of new tasks. Poisson regression is suitable for this analysis because it is useful for modeling count data and predicting the number of events, such as tasks, occurring within a given time period. In this manner, task management engine 120 may be configured to alert managers or organizations when a high number of tasks is predicted so that they can prepare and allocate resources accordingly.

In operation, based on the organization's operational needs, task prediction module 204 may be configured to execute or run at regular intervals. In some embodiments, task prediction module 204 may execute or perform a forecast weekly or daily, depending on the organization's typical pace of task creation. In some embodiments, task prediction module 204 may be employed ahead of times when workload typically spikes, such as the end of the month, to help with planning.

In some embodiments, task prediction module 204 may use a Poisson regression model to estimate how many new tasks will be created within a specified timeframe (e.g., within the next week). Due to its accurate modeling of count data, Poisson regression is ideal for forecasting the volume of new tasks based on historical trends. Task prediction module 204 may generate an annual forecast of new tasks using past task generation data along with any relevant seasonal or trend-based factors. In some embodiments, task prediction module 204 may send an alert to managers automatically when the predicted task volume exceeds a predefined threshold (for example, the organization's resource capacity). As a result of this alert, team members may be reallocated, deadlines for lower-priority tasks may be adjusted, or additional support may be arranged.

In some embodiments, task prediction module 204 may be configured to generate warnings when high task traffic is determined. For example, task prediction module 204 may be configured to alert managers when estimated tasks go beyond the defined limits to plan for resource allocation. Through this process, task prediction module 204 may assist in preventing missed deadlines and overwork for workers by planning for high demand, managing allocations of tasks for surges in workload, and preventing SLA violation through scalability planning in the context of service demand.

Task volume prediction is critical component for task management. With proactive resource planning, managers can prepare for high-demand periods before they occur, reducing the risk of missed deadlines and overworked employees. The ability to anticipate workload surges allows managers to allocate resources more effectively, ensuring that team members are not overwhelmed and that tasks are completed on time. For organizations with strict service level agreements or regulatory deadlines, task volume prediction ensures that capacity planning aligns with service requirements, thus minimizing the risk of service level breaches.

In operation, every time a task's priority or urgency changes, or a task volume prediction is available, the dashboard reflects these updates in real-time. For example, various task categories that are displayed on the dashboard may include including “Today,” “Scheduled,” and “Flagged.” Urgent tasks are highlighted prominently, ensuring they are visible to users and managers. It is also possible for managers to make timely decisions about resource allocation based on predicted task volumes, especially when high volumes are anticipated. Users may have the latest view of task status and workload forecasts because the dashboard dynamically updates based on new information from the prioritization and task prediction modules. The “urgent” section on the dashboard might be activated if an item that was previously non-urgent becomes urgent as a result of a change in deadline.

In some embodiments, prioritization module 202 may be configured to interface with task prediction module 204 to estimate how many new tasks to request based on past patterns and task interdependencies. Through this interface, prioritization module 202 may be configured to boost or improve task generation by finding inefficiencies or future needs in workflows.

Anomaly detection module 206 may be configured to process task variability and detect anomalies in generated tasks. In some embodiments, anomaly detection module 206 may employ a control chart (e.g., Shewhard, CUSUM, EWMA, etc.) for this analysis. For example, anomaly detection module 206 may employ a control chart to reveal whether a process is operating within expected limits or whether there are any unusual differences. In some embodiments, anomaly detection module 206 may employ control charts to monitor the rate at which tasks are completed or the frequency at which alerts can occur. In the event that the rate deviates significantly from the expected range, task management engine 120 may generate alerts to investigate potential issues, such as bottlenecks and incorrect data entry.

In some embodiments, prioritization module 202 may be configured to interface with anomaly detection module 206. For example, prioritization module 202 may be configured to acquire anomalies in task properties or user actions like unusual timeouts or unusual delays. Prioritization module 202 may be configured to fix reported anomalies to keep workflow in check.

Hazards module 208 may be configured to assess the impact of different factors on the time to complete a task in a survival analysis. For example, based on the characteristics of the task and historical data, hazards module 208 may be configured to estimate the duration of a given task. Such process may help in setting realistic deadlines and generating alerts if tasks are likely to exceed their expected completion time, thus enabling proactive management. In some embodiments, the hazards model may be a Cox proportional hazards model.

In some embodiments, prioritization module 202 may be configured to interface with hazards module 208. For example, prioritization module 202 may be configured t calculate risk factors or risks of a task, for proactive risk mitigation. Prioritization module 202 may mark potentially dangerous work as priority, so no delays or bottlenecks occur.

Bayesian module 210 may provide task management engine 120 with the additional functionality of modeling and managing task dependencies, thus allowing for more accurate prediction of task completion and resource requirements. For example, Bayesian module 210 may assist task management engine 120 in dynamically adjusting task priorities and generating alerts in response to changing conditions or new information, thus ensuring more responsive and adaptive management of tasks.

In some embodiments, prioritization module 202 may be configured to interface with Bayesian module 210. For example, prioritization module 202 may use Bayesian inference to update task predictions on the fly when information changes to improve decision-making using probabilistic logic.

Incorporating these modules into task management engine 120 greatly improves its task and alert management capabilities. Through workload projections, task prioritization, anomaly detection, and completion time predictions, these modules effectively optimize resource usage and ensure timely deadlines are met while proactively addressing potential issues. By seamlessly integrating statistical analysis into the alerting and to-do system, tracking platform's 116 operational efficiency is significantly enhanced, resulting in more informed decision-making processes.

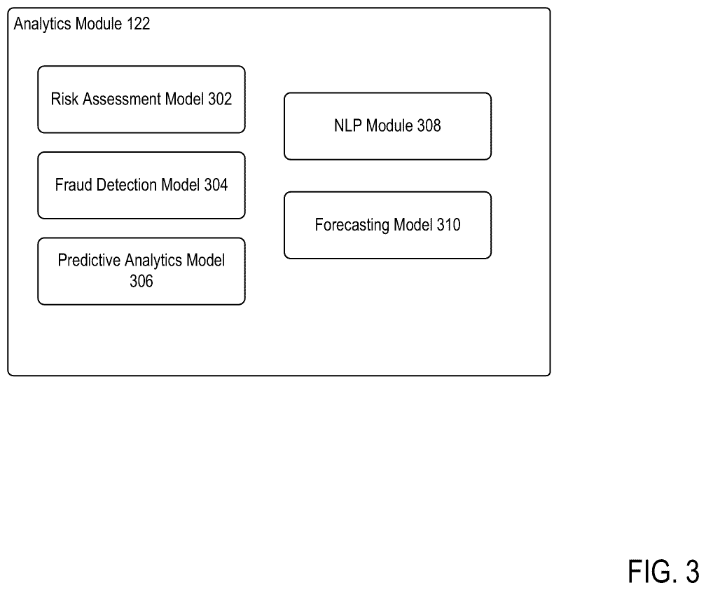

FIG. 3 is a block diagram illustrating analytics module 122, according to example embodiments. Tracking platform 116 combines advanced functionality of task management engine 120 and analytics module 122 for task prioritization, anomaly detection, hazard analysis and dependency management. For example, tracking platform 116 and analytics modules 122 may include various modules that utilize advanced statistical and machine learning algorithms to allocate resources more efficiently, maintain SLAs, and increase the productivity of workflows. As shown, analytics module 122 may include one or more of risk assessment model 302, fraud detection model 304, and predictive analytics model 306. In some embodiments, analytics module 122 may further include one or more of natural language processing (NLP) module 308 and forecasting model 310.

Risk assessment model 302 may be configured to analyze end user activity to identify patterns and factors that may influence eligibility risk. In some embodiments, risk assessment model 302 may be based on a gradient boosting machine trained on historical data, such as candidate profiles and historical candidate information (e.g., financial histories, repayment records, etc.) to identify those features that indicate risk. The sequential nature of GBM's training process is designed to minimize residual errors by learning from previous trees, one at a time. In the process of training, GBM calculates the residual error (difference between predicted and actual values) after each tree. The next tree is trained specifically to correct the residual error, gradually refining the model's predictions. A learning rate controls how much each tree contributes to the final prediction. Lower learning rates yield more accurate models but require more trees and therefore more computational power. Task management systems can be customized to reflect the nature of prioritization or prediction tasks, such as binary classification for prioritization (urgent vs. non-urgent) or regression for task volume prediction. By focusing on reducing specific types of errors relevant to the task, the objective function guides the model.

The following is an example of a training workflow in a task management system, such as tracking platform 116. The GBM model begins with a simple prediction (e.g., the mean value for regression or a base prediction for classification). The model calculates residuals (errors from previous predictions) for each subsequent tree. A new tree is then trained specifically on residuals, learning to correct previous mistakes. The learning rate is used to adjust the impact of the new tree's output with previous predictions. The process of repeating until convergence is repeated until the model reaches a certain level of accuracy, minimizing errors in predicting task urgency or task volume.

GBM's iterative approach captures complex interactions between features, such as the combined impact of deadline proximity and task complexity on urgency. By training on residuals, GBM produces a highly accurate prioritization or prediction model.

In some embodiments, risk assessment model 302 may be based on random forest models trained on historical data, such as candidate profiles and historical candidate information (e.g., financial histories, repayment records, etc.) to identify those features that indicate risk. Random forest models involve training multiple decision trees independently and in parallel. Each tree is trained on a random subset of data, using a technique known as bootstrapping. Each tree in the forest is trained on a different subset of training data (drawn randomly with replacement). This sampling introduces variability in the training process, causing each tree to be unique, and thereby improving the model's robustness. Random forest models also select a random subset of features at each split in each tree during training, preventing any one feature from dominating the prediction process. In this way, Random Forest is less likely to overfit certain data patterns. A Random Forest model aggregates the results of all trees after they have been trained to make a final prediction after all trees have been trained. For classification tasks (e.g., task urgency), this is typically a majority vote, while for regression tasks (e.g., task volume prediction), it is usually the average of all trees'predictions.

An example of a training workflow in a task management system is as follows. The system generates a specified number of trees (e.g., 100 trees), each trained on a randomly selected set of data. Using random feature subsets at each split enhances model diversity and prevents overreliance on specific features within each tree. Once training is complete, the model combines the predictions from all trees. In the context of task urgency, this might mean taking a majority vote across trees to classify each task as urgent or not urgent. Task volume prediction would be done by averaging the predictions from each tree.

The parallel nature of tree construction enables random forest models to be trained quickly, making it suitable for large datasets or real-time task management applications. Random forest models are also robust to overfitting and consistently performs well across a range of tasks, such as predicting task priority and volume, because it trains on different data subsets and uses random feature selection.

Fraud detection model 304 may be configured to analyze task information to determine whether an application for eligibility assessment may include fraudulent information. For example, fraud detection model 304 may be configured to analyze descriptions in a given task card to assess whether an application may be fraudulent. Fraud detection model 304 may be configured to employ one or more models to detect potential fraud in eligibility applications. In some embodiments, fraud detection model 304 may employ an isolation forest model trained on labeled transaction data to identify fraudulent information. In some embodiments, fraud detection model 304 may employ one-class support vector machines trained on labeled transaction data to identify information that may deviate from the norm.

In operation, analytics module 122 may use real-time data processing, monthly forecasting, and additional task data to prioritize tasks and better allocate resources. Analytics module 122 may be configured to leverage high performance prediction models, like support vector machines and neural networks, to support decisions on task and eligibility management workflows.

In operation, when users create or update tasks, analytics module 122 may be configured to for these events and extracts key attributes such as deadline proximity, complexity, and completion time in real time. It is then preprocessed and fed into the urgency prediction model, which categorizes tasks into “urgent” or “non-urgent.” Urgent tasks trigger alerts or notifications for immediate action.

For periodic forecasts, such as predicting weekly task volumes, analytics module 122 may schedule jobs to retrieve historical data. Task prediction module 204 may use aggregate metrics, such as average daily task counts and complexity. To prepare for increased workload, managers are alerted if forecasted task volumes exceed a set threshold.

To enrich task information, analytics module 122 may periodically pull data from external sources (e.g., CRM, project management tools) via API calls. This external data provides additional context (e.g., client priority), which helps improve model accuracy for urgency and task volume predictions.

In this way, the predictive models receive accurate, up-to-date information, allowing them to prioritize tasks effectively and allocate resources proactively.

Predictive analytics model 306 may be representative of a support vector machine or neural network configured to perform various predictive analytics to assess an individual's eligibility for a given application. Predictive analytics model 306 may be trained on a large data set of past applications (e.g., past credit applications), market conditions, and/or financial indicators.

In some embodiments, such as when predictive analytics model 306 is representative of a support vector machine, predictive analytics model 306 may perform one or more classification or regression-based tasks. For example, predictive analytics model 306 May be configured to categorize data based on patterns found in historical data. For example, predictive analytics model 306 may be configured to classify credit applications as “approved,” “under review,” or “high risk.” In some embodiments, the dashboard or report may display these classifications as tags or labels on each application. For example, high-risk applications are flagged in red, alerting underwriters to review them more closely.

In some embodiments, such as when predictive analytics model 306 is a regression-based model, predictive analytics model 306 may be configured to perform regression-based tasks, such as predicting continuous values. Exemplary predictions may include, but are not limited to credit scores, interest rates, or default rates for applications. The regression results are displayed in the form of numeric scores, trends, or graphs on the user interface. For example, a credit score estimate might be displayed beside each application to allow quick approval decisions.

In some embodiments, such as when predictive analytics model 306 is a deep learning model, predictive analytics model 306 may perform complex pattern recognition and future outcome predictions. The aim of a deep learning model is to identify intricate patterns across various data points (e.g., market conditions, applicant behavior) and predict possible future outcomes, such as the likelihood of an applicant defaulting within a year. Output from the deep learning model may be pushed to the interface, which may display a percentage indicating the probability of default or a recommendation on whether to accept or reject an application.

NLP module 308 may be trained to analyze unstructured data, such as applicant feedback, social media mentions, and news feeds to provide valuable insights. For example, NLP module 308 may be configured to extract sentiment and insight from unstructured data by analyzing, for example, applicant feedback, social media posts, and news articles, to gauge public sentiment. Based on the text data, analytics module 122 may generate insights in the form of summary insights, sentiment scores, or highlighted keywords. In the dashboard, for example, applicant feedback could signal frustration with approval times, prompting the review process to be adjusted accordingly. NLP module 308 may process unstructured data by extracting text content from relevant sources, such as feedback fields in applications, social media, or news feeds, and converting it into sentiment scores. In some embodiments, the text data may be cleaned and preprocessed prior to input to NLP module 308, which may include scaling numerical data, encoding categorical values, or removing irrelevant text.

Outputs from predictive analytics model 306 and/or NLP module 308 may be surfaced to end users through the dashboard that may display key outputs, like classifications, risk scores, and recommendations. High-risk or flagged applications are highlighted prominently. In addition, tracking platform 116 may generate regular reports or send alerts for high-priority cases. For example, an email alert might notify a manager about a sudden increase in high-risk cases. In some embodiments, the output may take the form of a variety of graphs, charts, and other visualizations are used to display regression predictions and deep learning insights, making it easy for users to explore the data interactively.

NLP-generated insights may be summarized in summary form. An example insight may be, for example: “80% of applicants expressed frustration about approval time,” allowing team members to quickly grasp public sentiment and adjust policies as necessary.

Forecasting model 310 may be representative of an autoregressive integrated moving average (ARIMA) model that may be configured to predict future workloads, potential compliance issues, and/or spikes in task volumes based on historical data trends. For example, forecasting model 310 may be configured to forecast when certain types of tasks will increase, thus allowing tracking platform 116 to generate alerts for resource planning and prioritize high-risk periods. For example, forecasting model 310 may be configured to trigger analytics module 122 to alert administrators to allocate resources accordingly in times when certain application types (e.g., loan applications) are at peak.

For example, if tracking platform 116 detects or predicts a surge in specific types of applications, such as loans, analytics module 122 may be called. For example, forecasting model 310 may identify this trigger based on historical data trends or real-time increases in application volume.

In some embodiments, when called, analytics module 122 may receive input data from a variety of sources. Exemplary input data may include but are not limited to historical task and application data to identify typical workload patterns, current task volumes using real-time application data, and/or external market conditions. Analytics module 122 may preprocess the input data and provide the input data into one or more predictive (e.g., predictive analytics model 306, forecasting model 310) to forecast upcoming peak periods.

In some embodiments, analytics module 122 may be configured to generate alerts if any of the models (e.g., predictive analytics model 306, forecasting model 310) predict an approaching peak in workload for specific application types based on the analysis of the data. In some embodiments, an interface generated by interface module 130 may be used to surface the outputs, which may be displayed on users'devices through application 110.

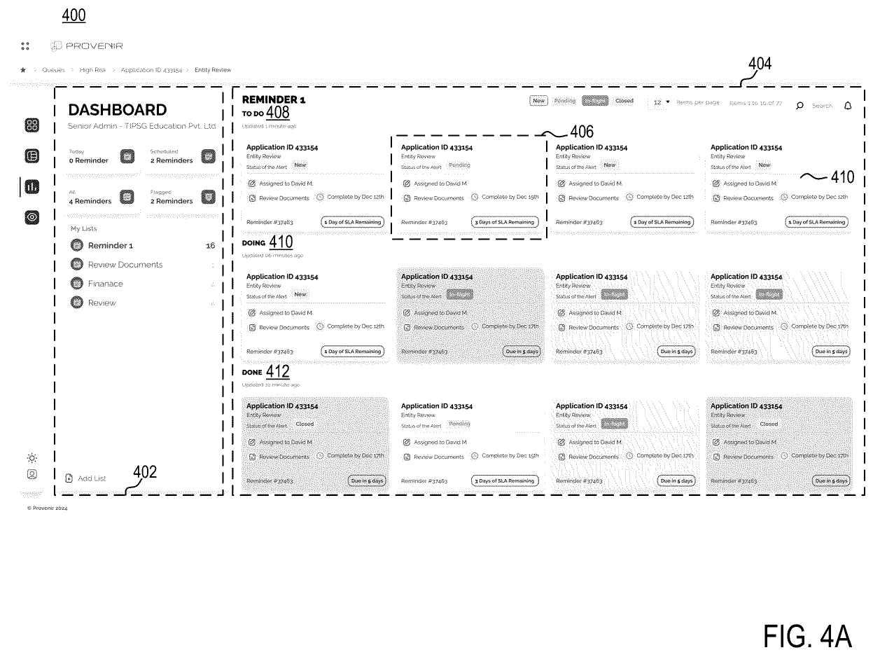

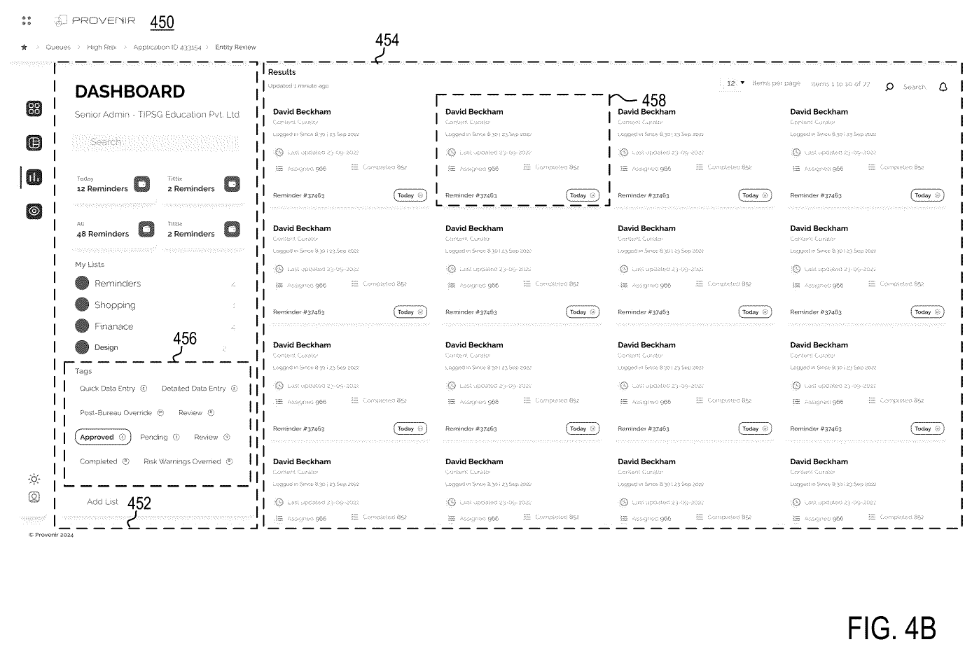

Analytics module 122 may combine the power of advanced models and user-friendly graphical user interfaces to support decision making, allocation of resources, and workflow control. With the power of predictive analytics model 306, NLP module 308, and forecasting model 310, together with an intuitive and structured GUI (such as that shown in FIGS. 4A-4B below), analytics module 122 provides end users with real-time insights, proactive planning, and time-based tasks.

Predictive analytics model 306, NLP module 308, and forecasting model 310 each play distinct roles in providing predictive insights, supporting resource planning, and ensuring proactive risk management. Each of these models contributes to overall operations in the analytics module 122.

For example, predictive analytics model 306 may handle classification and regression tasks when it is an SVM, thus allowing it to classify credit applications into categories such as “low-risk,” “medium-risk,” and “high-risk,” allowing high-risk applications to be prioritized. On the basis of historical data patterns, predictive analytics model 306 may also predict a continuous score representing creditworthiness or interest rates. Predictive analytics model 306 may also perform complex pattern recognition and long-term predictions by analyzing relationships within large datasets of past applications, financial indicators, and market conditions. Through deep learning, predictive analytics model 306 can detect nuanced patterns, such as correlations between applicant behavior, economic trends, and risk.

NLP Module 308 may analyze unstructured text data, such as applicant feedback, social media comments, and news articles. With NLP module 308, structured data can be processed to extract insights into sentiment, keywords, and potential risks. NLP module 308 may enable analytics module 122 to analyze public and applicant sentiment, both of which can be valuable for determining customer satisfaction, market perception, or emerging concerns. NLP module 308 may further be configured to identify trends through recurring keywords and themes. For example, if applicant feedback repeatedly mentions long processing times, this insight could lead to operational improvements. Additionally, insights from the NLP module 308 may be displayed in sentiment scores, keyword highlights, or summary insights. Managers can stay aware of potential issues by seeing that “75% of recent applicant feedback is positive,” or flagging keywords like “approval delay” if they occur frequently.

Forecasting model 310 may utilize an ARIMA model, to analyze historical data trends to predict future task volumes, compliance risks, or periods of high demand. Forecasting model 310 may enable prediction of future volumes of tasks or applications, allowing proactive planning. For example, if forecasting model 310 predicts a high volume of applications in the upcoming month, the organization can adjust its staffing or resource allocation.

Forecasting model 310 may also predict times when compliance risks might increase, enabling managers to take preventative measures. Forecasting model 310 may generate insights from unstructured data, such as sentiments and emerging concerns. Forecasting model 310 may enable resource planning and risk mitigation by forecasting future workload spikes and compliance risks.

Predictive analytics model 306, NLP module 308, and forecasting model 310 collectively work together to provide more responsive and efficient task management process, which provides comprehensive insights that support informed decision-making, risk management, and proactive resource planning.

By leveraging data-driven insights, tracking platform 116 can enhance its decision-making capabilities through the implementation of these machine learning models.

FIG. 4A illustrates an exemplary graphical user interface (GUI) 400 associated with tracking platform 116 and application 110, according to example embodiments. In some embodiments, GUI 400 may be generated by interface module 130 and sent to user device 102 for display via application 110. As shown, GUI 400 may provide users and administrators with detailed information about their tasks, reminders, and application statuses in tracking platform 116.

GUI 400 may illustrate an exemplary dashboard, generated by interface module 130, that illustrates existing tasks, along with their statuses. As shown, GUI 400 may include one or more sections—section 402 and section 404. Section 402 may provide an overview summary of reminders associated with a given individual, in this case a senior administrator, such as deadlines, task follow-ups, or action items that may need attention. As shown, section 402 includes an indication of how many reminders have deadlines of today, how many reminders are scheduled, how many reminders there are total, and how many reminders are flagged. In some embodiments, section 402 may also include a list of reminders that a user can easily review. Reminders allow users to quickly review pending obligations, helping them prioritize the tasks that require immediate attention. This feature improves task tracking and reduces the chances of overlooking deadlines or forgetting follow-ups.

Section 404 may generally correspond to a task overview section for senior administrators. Section 404 provides a comprehensive list of tasks assigned to the senior administrator in the form of a task card 406. Each task card 406 may include various information, such as a unique identifier associated with the task, status of the task (e.g., to do, doing, done), the assignee of the task (i.e., who is responsible for completing the task), the due date of the task, and an SLA indicator. The SLA indicator may indicate whether a task is in compliance with an SLA, which may be needed for meeting regulator or performance requirements. Section 404 thus provides a clear snapshot of all tasks and statuses by presenting each task as a card with relevant details. As a result, accountability is promoted, deadlines are managed effectively, and SLAs are met.

As shown, task cards 406 are organized according to their current status. For example, section 404 may include sub-section 408 corresponding to tasks that the individual needs to start (e.g., “To Do”), sub-section 410 corresponding to tasks that are currently underway (e.g., “Doing”), and sub-section 412 corresponding to tasks that are completed (“e.g., Done”). In addition to improving productivity and deadline adherence, organizing tasks by status allows for streamlined workflow tracking and allows administrators to focus on tasks that require immediate action.

FIG. 4B illustrates an exemplary graphical user interface (GUI) 450 associated with tracking platform 116 and application 110, according to example embodiments. In some embodiments, GUI 450 may be generated by interface module 130 and sent to user device 102 for display via application 110. As shown, GUI 450 may provide senior administrators with a quick summary of relevant reminders. A reminder overview assists administrators with staying on top of deadlines and tasks that need to be handled urgently. By presenting a summary, GUI 450 reduces cognitive load and allows the administrator to quickly assess what actions are due soon, improving task management and prioritization.

GUI 450 may illustrate an exemplary dashboard, generated by interface module 130, that illustrates existing tasks, along with their statuses. As shown, GUI 450 may include one or more sections—section 452 and section 454. Section 452 may provide an overview summary of reminders associated with a given individual, in this case a senior administrator. As shown, section 402 includes an indication of how many reminders have deadlines of today, how many reminders are scheduled, how many reminders there are total, and how many reminders are flagged. In some embodiments, section 452 may also include a list of reminders that a user can easily review. Section 452 may further include a plurality of tags 456 associated with one or more tasks. When a user selects one of the tags 456, section 454 may be updated to only show those tasks that are associated with a given tag—in this example the “approved” tag.

Section 454 may provide real-time view of task statuses and options to manage and update tasks within a certain workflow, such as eligibility assessments. facilitate efficient task allocation and progress Section 454 may include a plurality of tasks assigned to the senior administrator. Each task may take the form of a task card 458 that includes various information, such as the application identifier, status of the task, the assignee of the task, the due date of the task, and an SLA indicator. As shown, task cards 458 are presented based on whether they have been tagged with the tag selected by the end user. In this manner, an end user may easily view eligibility assessments that have been approved. Section 454 thus facilitates efficient task allocation and progress tracking by centralizing task monitoring and workflow management, facilitating efficient task allocation and workflow management. As a result, administrators are kept informed of workflow stages, ensuring smooth processes without bottlenecks.

Accordingly, GUI 400 and GUI 450 provide centralized interfaces for efficient task and workflow management, ensuring smooth operations and informed decision-making. For example, the dashboards offer end users an overview of tasks and workflows, allowing administrators to monitor progress and identify bottlenecks at a glance. The reminders highlight critical tasks and deadlines, ensuring that time-sensitive or high-risk activities are not overlooked. The task cards display task details, including SLA indicators and due dates, aiding in prompt prioritization and resource allocation. The workflow statuses provide real-time updates on task stages, keeping administrators informed and enabling proactive interventions. This structured GUI fosters accountability, prioritizes critical tasks, and supports efficient resource allocation, resulting in streamlined task management and improved outcomes.

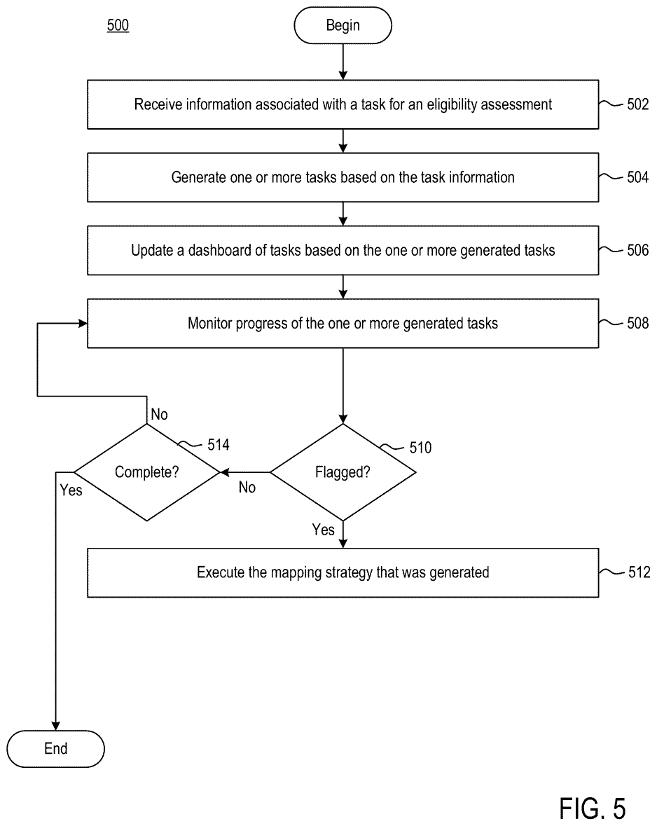

FIG. 5 is a flow diagram illustrating a method 500 of generating and tracking tasks for an eligibility assessment, according to example embodiments. Method 500 may begin at step 502.

At step 502, server system 104 may receive information associated with a task for an eligibility assessment. For example, task management engine 120 may receive detailed task information for the eligibility assessment and based on the detailed task information, may generate one or more tasks to be monitored or tracked. In some embodiments, the detailed task information may include, but is not limited to, task identifiers, descriptions, due dates, and assignees. In some embodiments, tagging module 126 may be configured to generate one or more tags for the task based on the task information that was provided.

At step 504, server system 104 may generate one or more tasks based on the task information that was received. For example, task management engine 120 may generate a data structure that includes the task identifier, description, due dates, and assignees specified by an end user. In some embodiments, task management engine 120 may employ prioritization module 202 to predict whether the task needs to be prioritized based on the task information. In some embodiments, task management engine 120 may further employ hazards module 208 to assess an expected duration for completing the task. The priority information and/or the expected duration may be stored in association with the task's data structure.

At step 506, server system 104 may update a dashboard of tasks based on the one or more tasks that were generated. For example, interface module 130 may be configured to generate one or more task cards corresponding to the one or more data structures that were generated for the one or more tasks. Each task card may include visual indicators corresponding to the task identifier, description, due date, assignee, priority, and/or expected duration of the task. Interface module 130 may be configured to populate the assignee's dashboard with the one or more task cards.

At step 508, server system 104 may monitor the progress of a given task. For example, in some embodiments, server system 104 may monitor the progress of a given task by employing analytics module 122 to process and/or analyze user activities, task progress, and/or SLA compliance in accordance with labels, generated by task management engine 120, that may indicate the current status and urgency of tasks in real-time or near real-time. In some embodiments, server system 104 may monitor the progress of a given task by employing tracking module 124 to track service level agreements to monitor deadlines and prioritize tasks based on contractual timelines set out in the task.

At step 510, server system 104 may determine whether a task should be flagged based on the monitoring of the task. For example, one or more modules associated with analytics module 122 may raise an alert that a task should be flagged for further review. For example, in some embodiments, risk assessment model 302 may be employed to determine whether a user's application raises an eligibility risk that exceeds a pre-determined threshold. In another example, fraud detection model 304 may be employed to determine whether an application for eligibility assessment includes fraudulent information.

If, at step 510, server system 104 determines that a task should be flagged, then method 500 may proceed to step 512. At step 512, server system 104 may generate and push an alert to the assignee that a given task was flagged. In some embodiments, tracking module 124 may be configured to push the alert to the assignee through their dashboard.

If, however, at step 510, server system 104 determines that the task should not be flagged, then method 500 may proceed to step. At step 514, server system 104 determines whether the task is complete. If, at step 514, server system 104 determines that the task is complete, then method 500 may end for that task. If, however, at step 504, server system 104 determines that the task is not complete, then method 500 may revert to step 508 for continued monitoring of the task.

### Exemplary Workflow

Through a user interface, tracking platform may receive task details such as task description, due date, priority level, tags, and assignees. In some embodiments interface module 130 may provide this interface in a fillable form format that may be designed to be user-friendly, with features like dropdowns for priority, calendar pickers for dates, and autocomplete fields for tags or assignees.

Tracking platform 116 may provide users with the functionality to input tasks in natural language (e.g., “Prepare compliance report by Friday for John”), which tracking platform 116 may parses and convert into structured task details using NLP techniques.

Before creating a task, tracking platform 116 may perform validation checks on user inputs. For example, tracking platform 116 may ensure the due date is valid and, in the future, priority levels are within the defined range, and required fields like task description are filled. In some embodiments, if certain fields are left blank, tracking platform 116 can auto-populate them with default values. For instance, if no priority level is specified, tracking platform 116 may assign it as “Medium” by default.

Once the task is validated, the data is used by tracking platform 116 to create a new task instance. Tracking platform 116 may assign a unique identifier to each task and stores relevant information, including timestamp metadata for tracking when the task was created. In some embodiments, based on specific keywords in the task description or user-specified parameters, tracking platform 116 may automatically assign tags to tasks. For example, any task containing “review” might automatically receive a “Compliance Review” tag.

After task creation, tracking platform 116 may categorize the task based on certain rules (e.g., due date proximity, priority level) and may assign it to categories like “Today,” “Flagged,” or “Scheduled.” This categorization helps organize the task dashboard. In some embodiments, such as in more complex implementations, tracking platform 116 may also route tasks to specific workflows or departments. For example, tasks tagged “Financial Review” might be automatically assigned to the finance team.

After a task is created, tracking platform 116 may provide real-time feedback to the user, showing a success message and displaying the newly created task in the appropriate dashboard category. For example, if there are any issues during task creation, such as missing required fields or invalid data, tracking platform 116 may generate error messages to guide the user in providing the correct information.

In some embodiments, tracking platform 116 may automatically update the dashboard in real-time or near real-time to reflect new tasks as they are created. For example, if a user adds a new “Today” task, the new task instantly appears in the “Today” section on the dashboard, ensuring users have an up-to-date view of their tasks. Users can then click on tasks within the dashboard to edit details such as description, due date, or priority. When changes are made, tracking platform 116 may validate and save the updates, reflecting them in real-time across all interfaces where the task appears. In some embodiments, if an edited task's attributes (e.g., due date) now fit a different category, tracking platform 116 may dynamically re-categorize the task and moves it to the appropriate section in the dashboard.

In some embodiments, every interaction, including task creation, editing, and deletion, is logged in a user activity log. This log enables accountability and provides audit trails for compliance and performance tracking purposes. The log includes timestamps, user IDs, and action types.

In some embodiments, users can filter tasks based on tags, categories, or priority levels, creating a personalized view that aligns with their specific needs. Depending on user roles, the dashboard displays tasks relevant to the user's responsibilities, ensuring that each user only sees tasks that pertain to their work scope.

By combining user-friendly input mechanisms, automated validation, real-time dashboard updates, and personalized task views, tracking platform 116 provides a streamlined and efficient way for users to create, manage, and track tasks within an organized and customizable framework.

The foregoing system supports complex task creation, administration and tracking capabilities inside tracking platform 116 using modules like interface module 130, analytics module 122, and task management engine 120. These components are integrated to enable real-time notifications, dynamic categorization and customized task dashboards for effective workflow management, reporting, and decision-making.

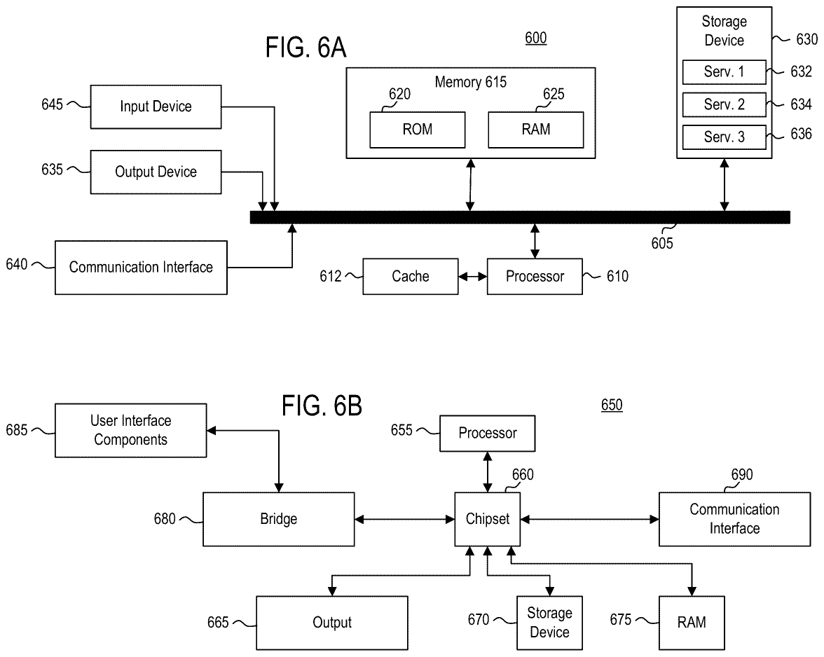

FIG. 6A illustrates a system bus architecture of computing system 600, according to example embodiments. System 600 may be representative of at least user device 102 or server system 104. One or more components of system 600 may be in electrical communication with each other using a bus 605. System 600 may include a processing unit (CPU or processor) 610 and a system bus 605 that couples various system components including the system memory 615, such as read only memory (ROM) 620 and random-access memory (RAM) 625, to processor 610.

System 600 may include a cache of high-speed memory connected directly with, in close proximity to, or integrated as part of processor 610. System 600 may copy data from memory 615 and/or storage device 630 to cache 612 for quick access by processor 610. In this way, cache 612 may provide a performance boost that avoids processor 610 delays while waiting for data. These and other modules may control or be configured to control processor 610 to perform various actions. Other system memory 615 may be available for use as well. Memory 615 may include multiple different types of memory with different performance characteristics. Processor 610 may include any general-purpose processor and a hardware module or software module, such as service 1 632, service 2 634, and service 3 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system 600, an input device 645 may represent any number of input mechanisms, such as a microphone for speech, a touch-sensitive screen for gesture or graphical input, keyboard, mouse, motion input, speech and so forth. An output device 635 may also be one or more of a number of output mechanisms known to those of skill in the art. In some instances, multimodal systems may enable a user to provide multiple types of input to communicate with computing system 600. Communications interface 640 may generally govern and manage the user input and system output. There is no restriction on operating on any particular hardware arrangement and therefore the basic features here may easily be substituted for improved hardware or firmware arrangements as they are developed.

Storage device 630 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 may include services 632, 634, and 636 for controlling the processor 610. Other hardware or software modules are contemplated. Storage device 630 may be connected to system bus 605. In one aspect, a hardware module that performs a particular function may include the software component stored in a computer-readable medium in connection with the necessary hardware components, such as processor 610, bus 605, output device 635 (e.g., display), and so forth, to carry out the function.

FIG. 6B illustrates a computer system 650 having a chipset architecture that may represent user device 102 or server system 104. Computer system 650 may be an example of computer hardware, software, and firmware that may be used to implement the disclosed technology. System 650 may include a processor 655, representative of any number of physically and/or logically distinct resources capable of executing software, firmware, and hardware configured to perform identified computations. Processor 655 may communicate with a chipset 660 that may control input to and output from processor 655.

In this example, chipset 660 outputs information to output 665, such as a display, and may read and write information to storage device 670, which may include magnetic media, and solid-state media, for example. Chipset 660 may also read data from and write data to storage device 675 (e.g., RAM). A bridge 680 for interfacing with a variety of user interface components 685 may be provided for interfacing with chipset 660. Such user interface components 685 may include a keyboard, a microphone, touch detection and processing circuitry, a pointing device, such as a mouse, and so on. In general, inputs to system 650 may come from any of a variety of sources, machine generated and/or human generated.

Chipset 660 may also interface with one or more communication interfaces 690 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 655 analyzing data stored in storage device 670 or storage device 675. Further, the machine may receive inputs from a user through user interface components 685 and execute appropriate functions, such as browsing functions by interpreting these inputs using processor 655.

It may be appreciated that example systems 600 and 650 may have more than one processor 610 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
receiving, by a computing system, information associated with a task for an eligibility assessment workflow, the information comprising a task identifier, a description, a due date, and an assignee for the task;
generating, by the computing system, one or more tasks based on the information by generating one or more data structures comprising the task identifier, the description, the due date, and the assignee, wherein generating the one or more tasks comprises:
prioritizing the one or more tasks by applying a logistic regression algorithm to parameters of the one or more tasks, the parameters comprising a deadline proximity, task complexity, and an expected time to completion, the logistic regression algorithm yielding an urgency score for each of the one or more tasks;
populating, by the computing system, a task management dashboard with graphical elements corresponding to the one or more tasks that were generated, each graphical element corresponding to a task card comprising visual indicators of the task identifier, the description, the due date, and the assignee, wherein each graphical element is ordered in accordance with an urgency score associated with a corresponding task of the one or more tasks;
monitoring, by the computing system, progress of the one or more tasks to ensure compliance with the due date;
analyzing, by the computing system, the progress of the one or more tasks to determine that a task should be flagged by inputting features associated with each task into a gradient boosting machine model trained on historical task data, the features comprising one or more of a deadline proximity, a task complexity, or a past completion times, wherein the gradient boosting machine model comprises an ensemble of trained decision trees, each tree being trained to correct residual errors of previous trees in the ensemble of trained decision trees, and wherein the gradient boosting machine model outputs a predicted urgency or risk score for each task based on aggregated outputs of the ensemble of trained decision trees, and tasks having a predicted urgency or risk score exceeding a predetermined threshold are identified as tasks that should be flagged;
based on the monitoring and the analyzing, detecting, by the computing system, a change to at least one parameter of the one or more tasks; and
responsive to the monitoring, analyzing, and detecting: re-prioritizing, by the computing system, the one or more tasks by applying the logistic regression algorithm to the changed parameters of the one or more tasks,
re-ordering, by the computing system, each graphical element in accordance with an upgraded urgency score associated with a corresponding task of the one or more tasks, and
generating and pushing, by the computing system, a notification to the assignee to flag the task.

2. The method of claim 1, wherein monitoring, by the computing system, the progress of the one or more tasks to ensure compliance with the due date comprises:
receiving service level agreement information associated with the task; and
monitoring compliance with the service level agreement information.

3. (canceled)

4. The method of claim 1, wherein analyzing, by the computing system, the progress of the one or more tasks to determine that a task should be flagged comprises:
analyzing activity associated with the task to identify an anomaly within the eligibility assessment workflow.

5. The method of claim 1, wherein generating, by the computing system, the one or more tasks based on the information by generating the one or more data structures comprising the task identifier, the description, the due date, and the assignee comprises:
estimating a duration for completing a given task in generating a due date for the given task.

6. The method of claim 1, further comprising:
analyzing, by the computing system, the one or more tasks and a plurality of other tasks assigned to the assignee;
identifying, by the computing system, a first task from the one or more tasks and the plurality of other tasks that should be prioritized; and
based on the identifying, re-organizing, by the computing system, the task management dashboard to prioritize the first task.

7. The method of claim 1, wherein analyzing, by the computing system, the progress of the one or more tasks to determine that a task should be flagged comprises:
analyzing descriptions associated with the task and determining, based on the analyzing, that the task comprises fraudulent information.

8. A non-transitory computer readable medium comprising one or more sequences of instructions, which, when executed by a processor, causes a computing system to perform operations comprising:
receiving, by a computing system, information associated with a task for an eligibility assessment workflow, the information comprising a task identifier, a description, a due date, and an assignee for the task;
generating, by the computing system, one or more tasks based on the information by generating one or more data structures comprising the task identifier, the description, the due date, and the assignee, wherein generating the one or more tasks comprises:
prioritizing the one or more tasks by applying a logistic regression algorithm to parameters of the one or more tasks, the parameters comprising a deadline proximity, task complexity, and an expected time to completion, the logistic regression algorithm yielding an urgency score for each of the one or more tasks;
populating, by the computing system, a task management dashboard with graphical elements corresponding to the one or more tasks that were generated, each graphical element corresponding to a task card comprising visual indicators of the task identifier, the description, the due date, and the assignee, wherein each graphical element is ordered in accordance with an urgency score associated with a corresponding task of the one or more tasks;
monitoring, by the computing system, progress of the one or more tasks to ensure compliance with the due date;
analyzing, by the computing system, the progress of the one or more tasks to determine that a task should be flagged by inputting features associated with each task into a gradient boosting machine model trained on historical task data, the features comprising one or more of a deadline proximity, a task complexity, or a past completion times, wherein the gradient boosting machine model comprises an ensemble of trained decision trees, each tree being trained to correct residual errors of previous trees in the ensemble of trained decision trees, and wherein the gradient boosting machine model outputs a predicted urgency or risk score for each task based on aggregated outputs of the ensemble of trained decision trees, and tasks having a predicted urgency or risk score exceeding a predetermined threshold are identified as tasks that should be flagged;
based on the monitoring and the analyzing, detecting, by the computing system, a change to at least one parameter of the one or more tasks; and
responsive to the monitoring, analyzing, and detecting:
re-prioritizing, by the computing system, the one or more tasks by applying the logistic regression algorithm to the changed parameters of the one or more tasks,
re-ordering, by the computing system, each graphical element in accordance with an upgraded urgency score associated with a corresponding task of the one or more tasks, and
generating and pushing, by the computing system, a notification to the assignee to flag the task.

9. The non-transitory computer readable medium of claim 8, wherein monitoring, by the computing system, the progress of the one or more tasks to ensure compliance with the due date comprises:
receiving service level agreement information associated with the task; and
monitoring compliance with the service level agreement information.

10. (canceled)

11. The non-transitory computer readable medium of claim 8, wherein analyzing, by the computing system, the progress of the one or more tasks to determine that a task should be flagged comprises:
analyzing activity associated with the task to identify an anomaly within the eligibility assessment workflow.

12. The non-transitory computer readable medium of claim 8, wherein generating, by the computing system, the one or more tasks based on the information by generating the one or more data structures comprising the task identifier, the description, the due date, and the assignee comprises:
estimating a duration for completing a given task in generating a due date for the given task.

13. The non-transitory computer readable medium of claim 8, further comprising:
analyzing, by the computing system, the one or more tasks and a plurality of other tasks assigned to the assignee;
identifying, by the computing system, a first task from the one or more tasks and the plurality of other tasks that should be prioritized; and
based on the identifying, re-organizing, by the computing system, the task management dashboard to prioritize the first task.

14. The non-transitory computer readable medium of claim 8, wherein analyzing, by the computing system, the progress of the one or more tasks to determine that a task should be flagged comprises:
analyzing descriptions associated with the task and determining, based on the analyzing, that the task comprises fraudulent information.

15. A system, comprising:
a processor; and
a memory having programming instructions stored thereon, which, when executed by the processor, causes the system to perform operations comprising:
receiving information associated with a task for an eligibility assessment workflow, the information comprising a task identifier, a description, a due date, and an assignee for the task;
generating one or more tasks based on the information by generating one or more data structures comprising the task identifier, the description, the due date, and the assignee, wherein generating the one or more tasks comprises:
prioritizing the one or more tasks by applying a logistic regression algorithm to parameters of the one or more tasks, the parameters comprising a deadline proximity, task complexity, and an expected time to completion, the logistic regression algorithm yielding an urgency score for each of the one or more tasks;
populating a task management dashboard with graphical elements corresponding to the one or more tasks that were generated, each graphical element corresponding to a task card comprising visual indicators of the task identifier, the description, the due date, and the assignee, wherein each graphical element is ordered in accordance with an urgency score associated with a corresponding task of the one or more tasks;
monitoring progress of the one or more tasks to ensure compliance with the due date;
analyzing the progress of the one or more tasks to determine that a task should be flagged by inputting features associated with each task into a gradient boosting machine model trained on historical task data, the features comprising one or more of a deadline proximity, a task complexity, or a past completion times, wherein the gradient boosting machine model comprises an ensemble of trained decision trees, each tree being trained to correct residual errors of previous trees in the ensemble of trained decision trees, and wherein the gradient boosting machine model outputs a predicted urgency or risk score for each task based on aggregated outputs of the ensemble of trained decision trees, and tasks having a predicted urgency or risk score exceeding a predetermined threshold are identified as tasks that should be flagged;
based on the monitoring and the analyzing, detecting a change to at least one parameter of the one or more tasks; and
responsive to the monitoring, analyzing, and detecting:
re-prioritizing the one or more tasks by applying the logistic regression algorithm to the changed parameters of the one or more tasks,
re-ordering each graphical element in accordance with an upgraded urgency score associated with a corresponding task of the one or more tasks, and
generating and pushing a notification to the assignee to flag the task.

16. The system of claim 15, wherein monitoring the progress of the one or more tasks to ensure compliance with the due date comprises:
receiving service level agreement information associated with the task; and
monitoring compliance with the service level agreement information.

17. (canceled)

18. The system of claim 15, wherein analyzing the progress of the one or more tasks to determine that a task should be flagged comprises:
analyzing activity associated with the task to identify an anomaly within the eligibility assessment workflow.

19. The system of claim 15, wherein generating the one or more tasks based on the information by generating the one or more data structures comprising the task identifier, the description, the due date, and the assignee comprises:
estimating a duration for completing a given task in generating a due date for the given task.

20. The system of claim 15, wherein the operations further comprise:
analyzing the one or more tasks and a plurality of other tasks assigned to the assignee;
identifying a first task from the one or more tasks and the plurality of other tasks that should be prioritized; and
based on the identifying, re-organizing the task management dashboard to prioritize the first task.
